(19) United States
(12) Patent Application Publication
(10) Pub. No.: US 2014/0366435 A1
(43) Pub. Date: Dec. 18, 2014

(54) METHOD AND DEVICE FOR PROTECTING TOMATO PLANTS

(71) Applicant: Julie Hewitt, Maryville, MO (US)

(72) Inventor: Julie Hewitt, Maryville, MO (US)

(21) Appl. No.: 13/916,799

(22) Filed: Jun. 13, 2013

(51) Int. Cl. A01G 13/04

(52) U.S. Cl. CPC A01G 13/043
USPC 47/29.1

(57) ABSTRACT

A device for protecting a plant including: a caged frame, where the caged frame includes spikes; a series of horizontal rods extending across a back side and a front side of the frame; a series horizontal rods extending the sides of the frame; a vertical rods extending vertically up each of the frame; and a plastic wrap, where the wrap fits around the caged frame. The spikes provide a mechanism to penetrate the ground and to secure the frame around a plant. The present invention further includes a method of protecting a plant including the steps of: placing frame around a plant; securing the frame around the plant by inserting spikes into a ground surface around the plant where the spikes extend from the frame; and placing a plastic wrap around the frame.

### BACKGROUND OF THE INVENTION

1. Field of Invention

The present invention relates to a method of protecting tomato plants from harsh weather conditions by using a cage frame and plastic wrap designed to seal the plant from harsh conditions.

2. Description of Related Art

Gardening is a common pastime for many individuals. Individuals grow several types of plants and flowers in their gardens on a yearly basis. Many gardeners take much time in preparing the soil and nurturing the plants for growth during the growing seasons. One common plant grown by gardeners is a tomato plant. The tomato plant is generally easy to grow and maintain and of course bears fruit for consumption. One drawback to gardening plants is the unexpected harsh weather conditions that may occur that will destroy a plant prematurely without the opportunity to fully develop into a vegetable or fruit-producing plant. Currently there are limited devices and methods that are available to protect plants from harsh weather conditions. Consequently it would be advantageous to have a device and method to address this issue for the gardener.

### SUMMARY OF THE INVENTION

The present invention relates to a device for protecting a plant comprising: a caged frame, where the caged frame includes spikes; a series of horizontal rods extending across a back side and a front side of the frame; a series horizontal rods extending the sides of the frame; a vertical rods extending vertically up each of the frame; and a plastic wrap, where the wrap fits around the caged frame. The spikes provide a means to penetrate the ground and to secure the frame around a plant. The present invention further includes a method of protecting a plant including the steps of: placing frame around a plant; securing the frame around the plant by inserting spikes into a ground surface around the plant where the spikes extend from the frame; and placing a plastic wrap around the frame.

### BRIEF DESCRIPTION OF DRAWINGS

FIG. 1 depicts a cage frame that is utilized to support a clear plastic wrap in accordance with the present invention.

FIG. 2 depicts the clear plastic wrap used in conjunction with the caged frame to protect a plant.

### DETAILED DESCRIPTION

The present invention relates to device and method of to protect plants during harsh weather conditions. The device includes a cage type frame over a series of spikes inserted into the ground to support the frame that surrounds the plant. Once the frame is in place a clear plastic wrap is placed around the caged frame to provide a protective seal or protective barrier for the plant.

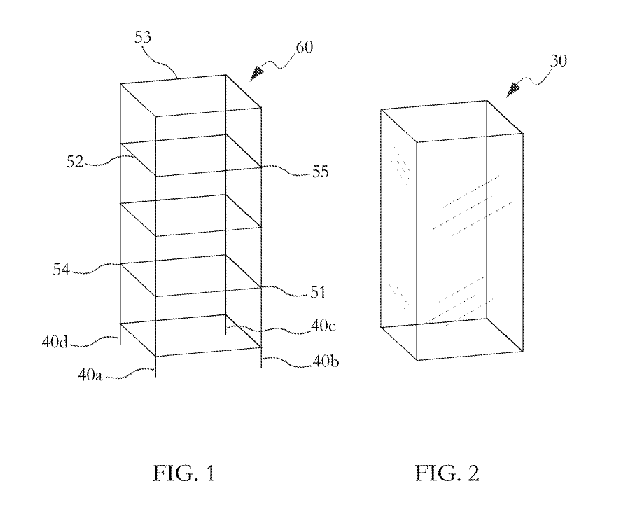

In reference to FIG. 1, a caged Frame 60 is depicted. The caged Frame 60 includes spikes 40a, 40b, 40c, 40d at the bottom portion of the caged Frame 60. The spikes provide a means to penetrate the ground and to secure the frame around a plant. The frame has a substantially rectangular cubed shape. The frame has a series of horizontal rods that is extend across the back side and front side of the cube 60. Horizontal rod 53 depicts a typical rod that extends horizontally across the back and front side in equally spaced sections along the Frame 60. In addition, perpendicular to this horizontal rod is a horizontal rod 52 that extends across the sides of the Frame 60. Vertical rods 51, 54 extend vertically in opposing corners of the Frame 60. Further similar vertical rods are provided in the opposing corners.

Once the Frame 60 is placed in ground surrounding a plant, a plastic wrap 30, as shown in FIG. 2, is placed around the Frame 60 to enclose the plant within the frame. Once the wrap is placed around the frame the plant is protected from wind, rain and other harsh conditions that may damage the plant.

Consequently the method of using the device includes placing the wire frame in a position surrounding the plant and then the placement of the clear plastic wrap 30 around the frame. This wrap encloses the plant, and therefore protects it from damage. This device and method of protecting the plant, typically a tomato plant, helps the plant to survive through the harsh weather conditions that may be temporary and then allow the gardener to remove the wrap as necessary once the weather conditions are more stable and suitable for growth. The wrap fits snugly across the caged frame to avoid removal or destruction during the harsh weather conditions. The instant invention has been shown and described in what it considers to be the most practical and preferred embodiments. It is recognized, however, that departures may be made there from within the scope of the invention and that obvious modifications will occur to a person skilled in the art.

What is claimed is:

1. A device for protecting a plant comprising:
a. a caged frame, where the caged frame includes spikes;
b. a series of horizontal rods extending across a back side and a front side of the frame;
c. a series horizontal rods extending the sides of the frame;
d. a vertical rods extending vertically up each of the frame; and
e. a plastic wrap, where the wrap fits around the caged frame.

2. The device according claim 1, where spikes provide a means to penetrate the ground and to secure the frame around a plant.

3. A method of protecting a plant including the steps of:
a. placing frame around a plant;
b. securing the frame around the plant by inserting spikes into a ground surface around the plant where the spikes extend from the frame; and
c. placing a plastic wrap around the frame.
